(19) United States
(12) Patent Application Publication
(10) Pub. No.: US 2025/0050285 A1
(43) Pub. Date: Feb. 13, 2025

(54) INSTALLATION AND METHOD FOR CONDITIONING A GAS MIXTURE

(71) Applicant: Air Liqide Electronics Systems, Paris (FR)

(72) Inventors: Vanina TODOROVA, Crolles (FR); Hervé DULPHY, Jarrie (FR); Frédéric LORAY, Jarrie (FR); Valere LAURENT, Montbonnot-Saint-Martin (FR); Ariel SATIN, Jarrie (FR); Christophe VIGNOT, Paris (FR)

(21) Appl. No.: 18/722,240

(22) PCT Filed: Nov. 28, 2022
(86) PCT No.: PCT/EP2022/083406

§ 371 Date: Jun. 20, 2024

(30) Foreign Application Priority Data
Dec. 20, 2021 (FR) FR2113983

(51) Int. Cl. B01F 23/10; B01F 35/21; B01F 35/221; B01F 35/71; F17C 5/00

(52) U.S. Cl. CPC B01F 23/191; B01F 35/21111; B01F 35/2211; B01F 35/2218; B01F 35/718051; F17C 5/00; F17C 2221/03; F17C 2250/032; F17C 2260/025; F17C 2265/02; F17C 2270/01

(57) ABSTRACT

The invention relates to a plant for packaging a gas mixture in one container (10), comprising a source of a minor gas (1), a source of a carrier gas (2), a mixer device (3), a first transfer circuit (6) fluidically connecting the source of minor gas (1) to the mixer device (3) and comprising a first flow regulator device (4), a second transfer circuit (7) fluidically connecting the source of a carrier gas (2) to the mixer device (3), a delivery circuit (8) comprising a second flow regulator device (9), the first transfer circuit (6) and the second transfer circuit (7) each include an expansion member (15, 16), the second flow regulator device (9) comprising a pressure raising member (9), the first flow regulator device (4) comprising several regulator members.

### CROSS REFERENCE TO RELATED APPLICATIONS

This application is a 371 of International Application No. PCT/EP2022/083406, filed Nov. 28, 2022, which claims priority to French Patent Application No. 2113983, filed Dec. 20, 2021, the entire contents of which are incorporated herein by reference.

### BACKGROUND

The present invention relates to a plant for preparing and packaging a gas mixture intended to be packaged in at least one fluid container. The invention also relates to a mixture packaging method implementing such a plant.

In particular, a plant and a method according to the invention are intended for the packaging of a mixture comprising one or more minor gases such as carbon dioxide, carbon monoxide, nitrogen dioxide, nitrogen monoxide, oxygen, hydrogen, hydrocarbons such as methane or propane, and comprising a carrier gas, in particular nitrogen, argon, helium.

The invention may be applied in particular to the preparation and packaging of mixtures of calibration gases used for the calibration and/or adjustment of gas analysis or detection equipment. The invention may also be applied to the packaging of gas mixtures used in the field of electronics, in particular in the production of integrated circuits and the fabrication of semiconductors.

Usually, the gas mixtures are packaged in compressed form in containers, in particular cylinders. The filling of a gas cylinder is carried out sequentially, the constituents of the mixture being introduced one after the other into the cylinder, starting with the constituent with the lowest content. For each constituent, a check on the amount of gas introduced into the cylinder is carried out, either by monitoring the pressure in the cylinder during and after the introduction of the constituent, or by weighing the cylinder during the introduction of the constituent. Such a plant for packaging gas mixtures is in particular described in document WO 2010/031940 A1.

In order to guarantee to the user reliability and reproducibility in the performance of their equipment, it is necessary to produce gas mixtures that offer great accuracy in terms of the concentration of each constituent. Depending on the application, the maximum tolerance for variation of the actual values of the concentrations relative to the target values may be 1% (relative %), or 0.7% or even less. The greater the number of constituents and/or the lower the contents thereof, the more difficult it is to meet such tolerances.

Depending on the required accuracy, the current packaging methods may prove insufficient. In particular, manometric packaging by controlling pressure offers an accuracy that is intrinsically limited by the accuracy of the pressure sensor and by the variations in temperature which influences the calculation of the amount of gas. Added to the uncertainty regarding the concentration values of the gas mixture produced are the differences in concentration between the mixtures packaged in different cylinders.

Gravimetric packaging by weighing the constituents offers greater accuracy regarding the composition of the mixture but still requires sequential filling of the cylinders. After each constituent is introduced, a waiting time is necessary to stabilize the measurement conditions before checking the quantity of gas introduced. Moreover, a final step of homogenization of the mixture is necessary, for example by setting the cylinder in motion using a cylinder roller.

In addition, analysis of the mixture is carried out after filling. Any difference with respect to the target concentration values is difficult, if not impossible to correct. This is the case in particular when the constituents must be introduced in a given order and some cannot be reintroduced subsequently, such as flammable constituents. And since the analyses are carried out individually on each cylinder, it is difficult to guarantee reproducibility of the contents of the mixture from one cylinder to another.

Another disadvantage of current packaging methods is their limited efficiency, with a daily rate typically of 8 to 10 cylinders per filling post. Furthermore, the cylinders are filled one by one, which requires disconnection and reconnection each time the cylinder is changed. Lastly, the choice of the composition of the mixture is limited by the constituents available at the filling post, placing constraints on the range of mixtures that can be produced.

The invention aims to overcome all or some of the drawbacks mentioned above, in particular proposing a plant for packaging a gas mixture which offers greater accuracy, reproducibility and flexibility in the composition of the mixture, as well as faster and more efficient filling of the fluid containers.

### SUMMARY

To this end, the solution of the invention is a plant for packaging a gas mixture in at least one container, said plant comprising:
a source of a minor gas,
a source of a carrier gas,
a mixer device fluidically connected to the source of minor gas and to the source of carrier gas, said mixer device being configured to produce, at an outlet, a gas mixture comprising the carrier gas and the minor gas,
a first transfer circuit fluidically connecting the source of minor gas to the mixer device, the first transfer circuit comprising a first flow regulator device configured to regulate the flow of minor gas flowing toward the mixer device according to a first flow setpoint determined as a function of a target content of minor gas in the gas mixture,
a second transfer circuit fluidically connecting the source of a carrier gas to the mixer device,
a delivery circuit configured to deliver the gas mixture from the mixer device to said at least one container, the delivery circuit comprising a second flow regulator device configured to regulate the flow of the gas mixture flowing toward the at least one container according to a second flow setpoint, the second flow regulator device comprising a pressure raising member, the first flow regulator device comprising several regulator members configured to regulate the flow of minor gas over respective flow ranges, the regulator members being arranged in parallel in the first transfer circuit, the plant comprising a control unit connected to the regulator members and configured to select at least one of the regulator members on the basis of at least one comparison of the first flow setpoint with a minimum value and/or a maximum value of at least one of the flow ranges, the control unit being configured to control the regulator members in such a way as to allow the minor gas to flow between the source of minor gas and the mixer device via said at least one selected regulator member and in such a way as to prevent the minor gas from flowing between the source of minor gas and the mixer device via the non-selected regulator member(s), the regulator members each comprising a flow meter associated with a regulator member.

Depending on the case, the invention may comprise one or more of the features mentioned below.

The first transfer circuit and the second transfer circuit each include an expansion member.

Such an expansion member makes it possible to carry out mixing at low pressure, which makes it possible to use more accurate regulator members. This therefore makes it possible to significantly improve the accuracy of the mixture.

The flow meter comprises a mass flow meter and the regulator member comprises a valve, in particular a piezoelectric valve.

Such a piezoelectric valve makes it possible, in combination with the expansion member and the pressure raising member, to significantly improve the accuracy of the mixture.

At least two of the regulator members are configured to regulate the flow of minor gas over respective flow ranges having different minimum flow values and/or different maximum flow values.

All of the regulator members are configured to regulate the flow of minor gas over respective flow ranges having different minimum flow values and/or different maximum flow values.

The second transfer circuit does not have any flow regulator device for regulating the flow of the carrier gas flowing toward the mixer device.

This makes it possible to simplify the plant, given that a pressure raising member is used at the outlet of the mixer.

The control unit is configured to select a regulator member for which the first flow setpoint is between the minimum flow value and the maximum flow value of the flow range of said regulator member, in particular when the first flow setpoint is less than or equal to the highest maximum value of the flow ranges of the regulator members.

When the first flow setpoint is greater than the highest maximum value of the flow ranges of the regulator members, the control unit is configured to select the regulator member having the flow range with the highest maximum value, to determine at least one new flow setpoint equal to the difference between the first flow setpoint and said highest maximum value and to select at least one other regulator member such that the new flow setpoint is between the minimum flow value and the maximum value of the flow range of said other regulator member.

The first flow regulator device comprises several regulator members configured to regulate the flow of minor gas toward the mixer device over successive flow ranges having increasing minimum values and increasing maximum values, the maximum value of at least one flow range being between the minimum value and the maximum value of the successive flow range, the control unit being configured to select the regulator member having the smallest minimum flow value when the flow setpoint or the new flow setpoint is between the maximum value of said at least one flow range and the minimum value of said successive flow range.

The extent of said at least one flow range is defined as the difference between its minimum value and its maximum value and the extent of the overlap zone is defined as the difference between the maximum value of said at least one flow range and the minimum value of said successive flow range, the overlap zone representing between 15 and 50%, preferably between 15 and 30%, of the extent of said at least one flow range.

Each of the regulator members may move between a closed position in which the flow of minor gas is zero and a fully open position in which the flow of minor gas has its maximum value, and the regulator members may take up at least one intermediate position between the closed position and the open position in which the flow of minor gas has its minimum value, the minimum value corresponding to a flow of minor gas equal to at least 20%, preferably at least 25%, more preferably at least 35%, of the respective maximum value.

The first transfer circuit comprises fluidic isolation means associated with each of the regulator members, said fluidic isolation means being operable in such a way as to allow the minor gas to flow between the source of minor gas and the mixer device via said at least one selected regulator member and to prevent the minor gas from flowing between the source of minor gas and the mixer device via the other non-selected regulator member(s).

The plant comprises several sources of minor gas, several first transfer circuits fluidically connecting each of the sources of minor gas to the mixer device, the first transfer circuits each comprising a first flow regulator device configured to regulate the flow of minor gas flowing toward the mixer device according to a first flow setpoint determined as a function of a target content of minor gas in the gas mixture, the plant further comprising third fluidic connection means each arranged in a transfer circuit between a respective first flow regulator device and the mixer device, each of the third fluidic connection means comprising at least one delivery valve movable in position in such a way as to allow or prevent the delivery of the minor gas coming from the first flow regulator device and an isolation valve arranged downstream of the delivery valve, said isolation valve being configured to fluidically isolate the delivery valve from the mixer device when the delivery valve is in a position preventing the delivery of the minor gas.

The pressure raising member comprises a pump or a compressor.

The pressure raising member is configured such that at least one operating parameter determines the flow of gas mixture flowing toward the container.

The second flow regulator device comprises a speed variator for varying the speed of a motor of the pressure raising member, the rotation speed of said motor determining the flow of gas mixture flowing toward the container, the second flow regulator device comprising a first flow controller connected to the speed variator and configured to measure the flow of gas mixture flowing toward said container, the first flow controller being configured to control and/or adjust a position of the flow variator device in such a way as to cause the flow of gas mixture measured to tend toward the second flow setpoint.

The second transfer circuit comprises a flow sensor or flow meter configured to measure the flow of carrier gas flowing as far as the mixer device.

The plant comprises an analysis unit configured to measure at least a content of minor gas and/or carrier gas in the gas mixture produced at the outlet of the mixer device, the control unit being connected to the analysis unit and configured to produce a control signal on the basis of at least one comparison of said at least one measured content with at least a target content of minor gas and/or a target content of carrier gas, and to adapt the first flow setpoint in response to said control signal.

The analysis unit produces a measurement signal representative of said at least one measured content, the control unit comprising a loop for regulating the first flow setpoint on the measurement signal supplied by the analysis unit, said loop comprising:
a comparator arranged within the control unit and configured to produce at least one error signal from a comparison of the measurement signal with at least one parameter chosen from: a target content of minor gas, a target content of carrier gas,
a corrector arranged within the control unit, in particular of proportional, integral and derivative type, and configured to produce the control signal from the error signal,
the regulator members being connected to the corrector and configured to move into position in response to said control signal.

The delivery circuit comprises a buffer tank arranged between the mixer device and the pressure raising member.

The plant comprises several containers fluidically connected to the delivery circuit by at least one filling station.

The plant comprises several modules and means for removably securing said modules, which modules include:
one or more minor gas modules, each minor gas module having a first wall to which are attached a first transfer circuit and first means for fluidic connection of the first transfer circuit to a respective source of minor gas,
one or more carrier gas modules, each carrier gas module having a second wall to which are attached the second transfer circuit and second means for fluidic connection of the second transfer circuit to a respective source of carrier gas,
third fluidic connection means configured to selectively connect the mixer device to one or more first transfer circuits and to one or more second transfer circuits.

Furthermore, the invention relates to a method for packaging a gas mixture, comprising the following steps:
a) passing a minor gas through a first transfer circuit comprising a first flow regulator device in such a way as to deliver the minor gas to a mixer device according to a first flow setpoint determined as a function of a target content of minor gas in the gas mixture,
b) passing a carrier gas through a second transfer circuit in such a way as to deliver the carrier gas to the mixer device,
c) producing, through an outlet of the mixer device, a gas mixture comprising the minor gas and the carrier gas,
d) passing the gas mixture through a delivery circuit comprising a second flow regulator device in such a way as to deliver the gas mixture to said at least one container according to a second flow setpoint, the second flow regulator device comprising a pressure raising member, the first flow regulator device comprising several regulator members arranged in parallel in the first transfer circuit, the regulator members being configured to regulate the flow of minor gas over respective flow ranges, the method further comprising the following steps:
e) comparing the first flow setpoint with at least one minimum value and/or at least one maximum value of at least one of the flow ranges,
f) selecting at least one of the regulator members on the basis of the comparison carried out in step e) and controlling the regulator members in such a way as to selectively allow the minor gas to flow between the source of minor gas and the mixer device via said at least one selected regulator member and in such a way as to prevent the minor gas from flowing between the source of minor gas and the mixer device via the non-selected regulator member(s).

Depending on the case, the invention may comprise one or more of the features mentioned below.

The first transfer circuit and the second transfer circuit each include an expansion member.

The regulator members each include a flow meter associated with a regulator member.

The flow meter comprises a mass flow meter and the regulator member comprises a valve, in particular a piezoelectric valve.

At least two of the regulator members are configured to regulate the flow of minor gas over respective flow ranges having different minimum flow values and/or different maximum flow values.

All of the regulator members are configured to regulate the flow of minor gas over respective flow ranges having different minimum flow values and/or different maximum flow values.

The second transfer circuit does not have any flow regulator device for regulating the flow of the carrier gas flowing toward the mixer device.

The features relating to the plant, as described above, are applicable individually or in combination to said method.

Lastly, the invention relates to a plant for packaging a gas mixture in at least one container, said plant comprising:
a source of a minor gas,
a source of a carrier gas,
a mixer device fluidically connected to the source of minor gas and to the source of carrier gas, said mixer device being configured to produce, at an outlet, a gas mixture comprising the carrier gas and the minor gas,
a first transfer circuit fluidically connecting the source of minor gas to the mixer device, the first transfer circuit comprising a first flow regulator device configured to regulate the flow of minor gas flowing toward the mixer device according to a first flow setpoint determined as a function of a target content of minor gas in the gas mixture,
a second transfer circuit fluidically connecting the source of a carrier gas to the mixer device,
a delivery circuit configured to deliver the gas mixture from the mixer device to said at least one container, the delivery circuit comprising a second flow regulator device configured to regulate the flow of the gas mixture flowing toward the at least one container according to a second flow setpoint, characterized in that the first flow regulator device comprises a set of regulator members arranged in parallel in the first transfer circuit, the regulator members being configured to regulate the flow of minor gas over respective flow ranges having different minimum flow values and different maximum flow values, the plant comprising a control unit connected to the regulator members and configured to select at least one of the regulator members on the basis of at least one comparison of the first flow setpoint with a minimum value and/or a maximum value of at least one respective flow range, the control unit being configured to control the regulator members in such a way as to allow the minor gas to flow between the source of minor gas and the mixer device via said at least one selected regulator member and in such a way as to prevent the minor gas from flowing between the source of minor gas and the mixer device via the non-selected regulator member(s).

### BRIEF DESCRIPTION OF THE DRAWINGS

The invention will now be better understood from the following detailed description, which is provided by way of non-limiting illustration, with reference to the appended figures described below.

FIG. 1 schematically shows the operation of a plant according to an embodiment of the invention,

FIG. 2 schematically shows flow ranges of a first flow regulator device according to embodiments of the invention,

FIG. 3 schematically shows the operation of a plant according to another embodiment of the invention,

FIG. 4 shows an embodiment of a plant according to the invention comprising an assembly of several modules.

### DETAILED DESCRIPTION OF THE PREFERRED EMBODIMENTS

FIG. 1 shows a plant according to the invention comprising a source of minor gas 1 and a source of carrier gas 2. The minor gas 1 and the carrier gas 2 are of different nature. They are preferably pure, simple or compound bodies. Each source of gas may be a gas cylinder, typically a cylinder that may have a water volume of up to 50 L, or a set of cylinders connected to one another to form a bundle of cylinders or a tank of greater capacity, in particular a capacity of up to 1000 L, such as a cryogenic storage tank or a tank arranged on a lorry trailer. Preferably, the sources deliver fluids in the gaseous state. Before delivery, the fluids may be stored in the gaseous state, in the liquid state, i.e. liquefied gases, or in the liquid/gas two-phase state.

FIG. 1 depicts the case where the plant is configured to produce a binary gas mixture, i.e. containing two constituents, from two sources of gas. Of course, a plant according to the invention could produce mixtures containing more than two constituents, in particular ternary or quaternary gas mixtures. The mixture may thus include a carrier gas and several different minor gases. “Minor gas” means a gas the content of which in the mixture is lower than the content of carrier gas. “Carrier gas” means a gas which is predominant in the mixture, in particular a gas the content of which in the mixture is at least 50%, more particularly at least 60%, or even at least 80%.

Each source of gas 1, 2 is connected respectively by a first 6 and a second transfer circuit 7 to a mixer device 3. The first transfer circuit 6 comprises a first line 12 and a first flow regulator device 4 connected to the first line 12 and configured to regulate the flow of minor gas flowing toward the gas mixer device 3 according to a first flow setpoint D1. The plant further comprises a control unit 5 which is connected to the first flow regulator device 4 in such a way as to control operation thereof in accordance with the first flow setpoint D1.

Preferably, the first transfer circuit 6 is advantageously split into several branches 6a, 6b, 6c, 6d arranged in parallel and each fluidically connected to the source of minor gas 1 on the one hand and to the mixer 3 on the other hand. Note that the branches 6a, 6b, 6c, 6d may either be connected to a common line supplying the mixer device 3, as shown, or be connected directly to the mixer device 3. Each branch 6a, 6b, 6c, 6d comprises a regulator member 41, 42, 43, 44.

The second transfer circuit 7 comprises a second line 22. Preferably, the lines 12, 22 each open into two separate inlets of the mixer device 3. Note that it may also be envisaged that the lines 21, 22 join together at a connection point located upstream of the mixer device in order to form a shared line portion connected to an inlet of the mixer device.

Typically, the mixer device 3 comprises a common mixer volume into which the inlet(s) and the outlet 33 of the mixer open and in which the mixture is homogenized. Use could for example be made of a mixer 3 of static mixer type enabling a continuous mixing of the fluids entering the mixer. This type of mixer generally comprises at least one disturbing element, such as a plate, a portion of pipe, an insert, capable of disturbing the flow of the fluids, generating pressure drops and/or turbulence in order to promote the mixing of the fluids and the homogenization thereof.

A delivery circuit 8 connects an outlet of the mixer device 3 to one or more containers 10 adapted to contain the gas mixture. The delivery circuit 8 comprises a second flow regulator device 9 configured to regulate and/or adjust the flow of gas mixture flowing toward the container 10 according to a second flow setpoint D.

In practice, the mixer device 3 produces at its outlet a gas mixture flowing with a delivery flow D which corresponds, in the case of a mixture with two constituents, to the sum of the flows of minor gas and carrier gas supplying the mixer device 3. The flow of carrier gas depends on the delivery flow of the mixture D and on the desired content C1 of minor gas. It corresponds to the difference between the flow of mixture D and the flow of minor gas D1. Preferably, the second transfer circuit does not have any device adapted to regulate and/or adjust the flow of carrier gas, the latter resulting from the flow setpoints for the minor gas and the carrier gas.

Note that if the plant is intended for the delivery of a mixture with two minor gases in the carrier gas, the flow D is the sum of the flows of each minor gas and of the carrier gas.

The first flow setpoint D1 is determined as a function of a target content C1 of minor gas. Preferably, the control unit 5 calculates the first flow setpoint D1 in relation to the second flow setpoint D desired for the mixture and the target content C1, such that the ratio D1/D corresponds to C1.

Let us consider the example of a plant configured to produce a two-gas mixture with a delivery flow D at the outlet of the mixer device 3 of 1666.66 sL/min (standard liter per minute), i.e. 100 Nm³/h (normal cubic meter per hour). The normal cubic meter is a unit for measuring the amount of gas which corresponds to the content of a volume of one cubic meter, for a gas that is under normal temperature and pressure conditions (0° C. or 15° C. or less commonly 20° C. depending on the frames of reference and 1 atm, i.e. 101 325 Pa). For a pure gas, one normal cubic meter corresponds to around 44.6 mol of gas. The desired gas mixture is a mixture made up of the minor gas at a target content C1 of 10 ppm (ppm by volume), the remainder being the carrier gas. A first flow setpoint D1 of 0.017 sL/min, corresponding to a proportion of 0.001% relative to D, is therefore applied to the flow regulator device 4. If the target content C1 is 5000 ppm, the total flow still being 100 Nm³/h, the first setpoint D1 is 8.33 sL/min.

Preferably, the control unit 5 does not calculate a carrier gas flow setpoint, the fluid circuits of the plant being configured such that the flow of carrier gas is regulated via the regulation of the flows of minor gas and the delivery flow.

According to one possibility of implementation, the control unit 5 comprises a human-machine interface comprising an input interface, for example a touch screen, allowing a user to input the target content of the first gas and the delivery flow desired for the gas mixture. For example, the contents may be expressed as a volume percentage of first gas present in the gas mixture. More generally, the human-machine interface may allow the user to give instructions to the control unit 5.

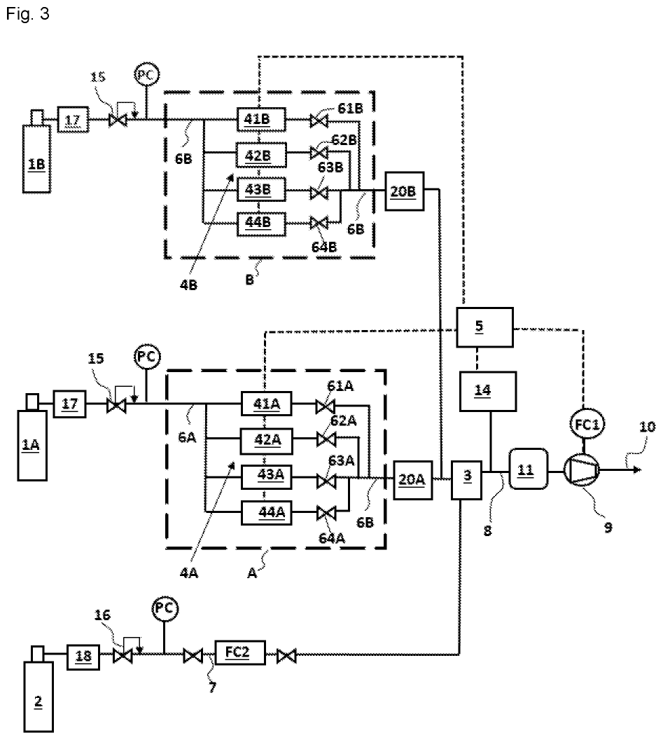

Advantageously, the control unit 5 comprises a programmable controller, also referred to as a PLC (Programmable Logic Controller) system, i.e. a control system for an industrial process comprising a human-machine interface for supervision and a digital communication network. The PLC system may comprise several modular controllers which control the control sub-systems or equipment of the plant. These pieces of equipment are each configured to ensure at least one operation from among: acquisition of data from at least one measurement sensor, control of at least one actuator connected to at least one flow control member, the regulation and feedback of parameters, the transmission of data between the various pieces of equipment of the system. Note that in FIG. 1 and in FIG. 3, the signals received and sent between the various elements of the plant are shown schematically by dotted lines.

The control unit 5 may thus comprise at least one from among: a microcontroller, a microprocessor, a computer. The control unit 5 may be connected to the various pieces of control equipment of the plant, in particular to the flow regulator members, to the sensors, and communicate with said pieces of equipment by electrical, Ethernet, Modbus, etc. connections. Other modes of connection and/or transmission of information may be envisaged for all or some of the equipment of the plant, for example by radiofrequency, WIFI, Bluetooth, etc. connections.

According to the invention, the first flow regulator device 4 comprises several regulator members 41, 42, 43, 44 arranged in parallel in the first transfer circuit 6. The regulator members 41, 42, 43, 44 are configured to regulate the flow of minor gas over respective flow ranges having different minimum flow values and different maximum flow values.

The control unit 5 is configured to select one of these regulator members 41, 42, 43, 44 on the basis of at least one comparison of the first flow setpoint D1 with the minimum and maximum values of at least one respective flow range. The control unit 5 is connected to the regulator members 41, 42, 43, 44. Depending on the result of the comparison, the control unit 5 controls the operation of the regulator members 41, 42, 43, 44 in such a way as to selectively allow the minor gas to flow between the source of minor gas 1 and the mixer device 3 via the at least one regulator member 41, 42, 43, 44 which has been selected by the control unit 5.

The plant according to the invention makes it possible to simultaneously package the constituents of the mixture in a container 10. The flow of gas mixture is driven by the pressure raising member, which ensures a large flow of gas mixture toward the container 10 and therefore packaging of the mixture more quickly and in a greater number of containers in a given time. The composition of the mixture is more homogeneous between different containers.

The pressure raising member also makes it possible to regulate the flow of gas mixture.

In addition, the selective use of the flow regulator members as a function of their operating range and of the desired flow setpoint makes it possible to produce mixtures of more accurately controlled composition. To be specific, the flow regulator members are components calibrated for a given flow scale. Typically, the regulator members are preset at the factory with reference flows. The smaller the flow scale of a regulator member, the greater its accuracy. Working with several regulator members having targeted flow ranges rather than with one regulator member having a broader flow range, makes it possible to cover a large span of flows, and therefore of desired minor gas contents, while guaranteeing great accuracy of the mixture since it is the best sized regulator member which is selected.

Each regulator member 41, 42, 43, 44 is a flow regulator member that may be any means configured to set, regulate, adjust the flow rate of a fluid in order to bring it to a flow value closest to the setpoint, i.e. to the desired value.

Typically, the flow regulator members each comprise a flow sensor, or flow meter, combined with a regulation member, such as a valve, for example a proportional control valve. Such flow regulator members are more accurate, which makes it possible to improve the accuracy of the mixture.

The valve may be piezoelectric, analogue or digital. The valve comprises a moving part, typically at least one closure member, which is placed in the flow of fluid and the movement of which makes it possible to vary the passage cross section, and thus to vary the flow in order to bring it to the setpoint value. In particular, the flow regulator members may be mass flow regulators comprising a mass flow sensor and a proportional control valve. Note that even if the regulation is based on a measurement of mass of fluid, the setpoint and measured flow values are not necessarily expressed by mass. Thus, a volume flow setpoint may be expressed as a percentage opening of the proportional control valve, to which a voltage value to be applied to the control valve of the regulator member corresponds. The conversion between percentage opening and mass or volume flow value is achieved by knowing the nominal value of the regulated flow for 100% opening.

According to one advantageous embodiment, the valve is piezoelectric. This type of valve offers great accuracy, good reproducibility thanks to the monitoring of the voltage applied to the valve. Such valves are also relatively insensitive to magnetic fields and radio-frequency noise. Their energy consumption is low with minimal heat generation. The metal on metal control surface reduces, or even eliminates, reactions with the gas. Finally, owing to a relatively small flow control cavity volume, in particular compared to that of a solenoid valve, it is possible to have an excellent dynamic response.

The flow regulator members 41, 42, 43, 44 each advantageously comprise a closed-loop regulation system which is given flow setpoints by the control unit 5. These setpoints are then compared by the closed-loop regulation system to the values measured by the flow sensors of the flow regulator members and the positions thereof are consequently adjusted by said system to send to the mixer device 3 the flow closest possible to the first setpoint D1.

According to an advantageous embodiment, the first transfer circuit 6 comprises fluidic connection means 61, 62, 63, 64, such as valves, associated with each of the regulator members 41, 42, 43, 44. The fluidic connection means 61, 62, 63, 64 are configured in such a way as to prevent fluidic communication between the mixer device 3 and the source 1 by regulator members 41, 42, 43, 44 which are not selected. As shown for example in FIG. 1, each branch 6a, 6b, 6c, 6d comprises a respective regulator member 41, 42, 43, 44 associated with a respective fluidic connection means 61, 62, 63, 64. The fluidic connection means 61, 62, 63, 64 may be arranged upstream or downstream of the regulator members 41, 42, 43, 44.

In operation, the minor gas coming from the source 1 supplies the regulator members 41, 42, 43, 44. In the case of a regulator member 41, 42, 43, 44 selected by the control unit 5, the fluidic connection means 61, 62, 63, 64 associated therewith is positioned in such a way as to allow the passage of minor gas toward the mixer device 3. In the case of a regulator member 41, 42, 43, 44 not selected by the control unit 5, the fluidic connection means 61, 62, 63, 64 associated therewith is positioned in such a way as to isolate the regulator member fluidically from the mixer device 3.

The fluidic connection means 61, 62, 63, 64 act as fluidic isolation means between the source 1 and the mixer 3. Thus, even when a regulator member is not selected and is therefore in the closed position, which corresponds to a zero flow setpoint, leaks can still occur through this regulator member. The fluidic connection means 61, 62, 63, 64 make it possible, in addition to the possibility of placing a regulator member in the closed position, to fluidically isolate this regulator member. It is thus possible to do away with any internal leaks, however minimal, which could influence the content of minor gas in the mixture. This improves accuracy in low-content mixtures, typically down to contents as low as 2 to 3 ppm.

Preferably, the control unit 5 is configured to select a single regulator member 41, 42, 43, 44 for which the first flow setpoint D1 is between the minimum value and the maximum value of the flow range of said regulator member 41, 42, 43, 44.

According to another possibility, the control unit is configured to select several regulator members from among the set of regulator members 41, 42, 43, 44, such that the first flow setpoint D1 is between the sum of the minimum flow values of the selected members and the sum of the maximum flow values of the selected members. This possibility is implemented in the case where the first flow setpoint D1 is greater than the highest maximum value of the flow ranges of the regulator members. In particular, the control unit 5 may be configured in such a way as to determine several intermediate flow setpoints the sum of which is equal to the first setpoint D1. Each selected regulator member regulates a partial flow of minor gas according to the intermediate flow setpoint applied to it. The intermediate flows delivered by each regulator member are then recombined to form the flow of minor gas circulating toward the mixer device 3. Working simultaneously with several regulator members makes it possible to achieve higher minor gas contents, without detrimentally affecting the accuracy of these contents.

Preferably, when the first flow setpoint D1 is greater than the highest maximum value of the flow ranges of the regulator members 41, 42, 43, 44, the control unit 5 is configured to select the regulator member having the flow range with the highest maximum value from among the regulator members 41, 42, 43, 44 of the plant. The electronic logic 5 determines at least one new flow setpoint Dₙ equal to the difference between the first flow setpoint D1 and said highest maximum value and compares the new setpoint Dₙ with a maximum value and/or a minimum value of a flow range of at least one other regulator member 41, 42, 43, 44, and selects another regulator member for which the new flow setpoint Dₙ is between the minimum flow value and the maximum value of the flow range of said other regulator member. Note that these steps may be repeated if the new flow setpoint determined first remains greater than the highest maximum value of the flow ranges of the regulator members 41, 42, 43, 44. Note that if a regulator member has already been selected, it cannot be selected again. Preferably, the electronic logic does not compare setpoints with maximum and/or minimum values of the range of a regulator already selected.

Advantageously, the first flow regulator device 4 comprises several regulator members 41, 42, 43, 44 configured to regulate the flow of minor gas toward the mixer device 3 respectively over successive flow ranges. “Successive” means flow ranges which follow one another in an increasing order of flow such that these ranges have increasing minimum values d_{min i}, d_{min i+1}, . . . and increasing maximum values d_{max i}, d_{max i+1}, . . .

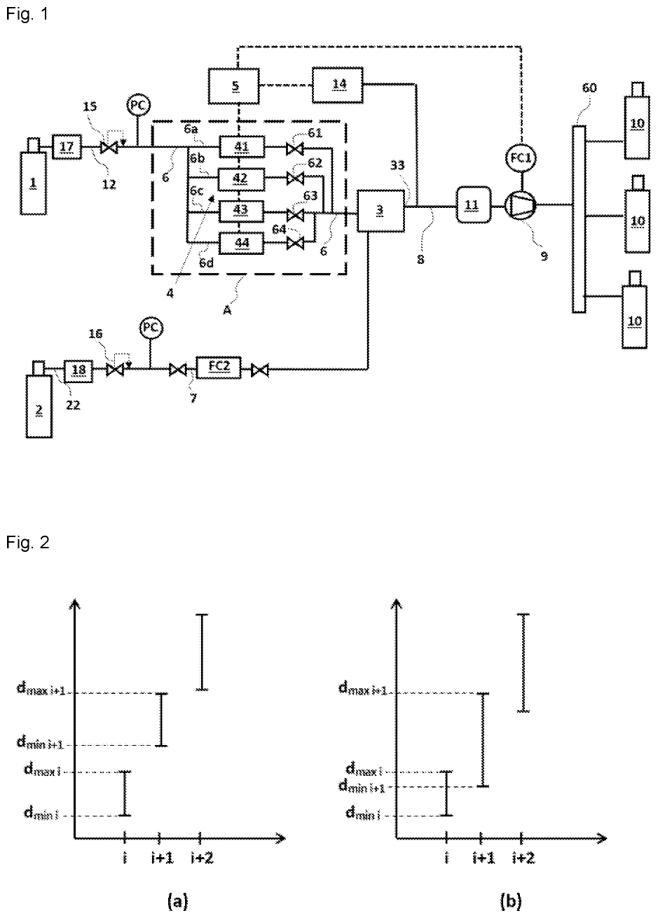

According to an embodiment an example of which is illustrated in (a) in FIG. 2, the successive flow ranges may cover a discontinuous flow span, that is to say that the flow ranges of each regulator member are not necessarily contiguous. Note that the plant according to the invention may be modular and that the user may, depending on the contents they wish to obtain in the mixture, add one or more regulator members with operating ranges making it possible to achieve the missing contents.

According to another embodiment an example of which is illustrated in (b) in FIG. 2, the maximum value d_{max i} of at least one flow range may be between the minimum value d_{min i+1} and the maximum value d_{max i+1} of the successive flow range, that is to say the flow range coming consecutively after said at least one range in increasing order of flow. The control unit 5 is configured to select the regulator member having the smallest minimum flow value d_{min i} when the flow setpoint D1 is between the maximum value d_{max i} of said at least one flow range and the minimum value d_{min i+1} of said successive flow range. The advantage of having an overlap zone between successive flow ranges is that it makes it possible to avoid selecting another regulator member inopportunely, something which could happen if the first setpoint D1 is at the limit between two successive ranges, which enhances the operating stability of the plant. When the flow setpoint is located in such an overlap zone, selecting the regulator member having a flow range at a lower level in the total span of flows makes it possible to work in the upper part of this range, where the accuracy of the regulator member is highest. The composition of the mixture delivered is thus more accurate.

In the case illustrated in (b), three flow regulator members are operating in three possible flow ranges, the first range having the lowest minimum value. The first range has an overlap zone with the second successive range and the second range has an overlap zone with the third successive range.

The extent of said at least one flow range is defined as the difference between its minimum value d_{min i} and its maximum value d_{max i} and the extent of the overlap zone is defined as the difference between the maximum value d_{max i} of said at least one flow range and the minimum value d_{min i+1} of said successive flow range, the extent of the overlap zone representing between 15 and 50%, preferably between 15 and 30%, of the extent of said at least one flow range. This makes it possible to further improve the reliability of the operation of the plant.

In the context of the invention, each of the regulator members 41, 42, 43, 44 may preferably move between a closed position in which the flow of minor gas is zero and a fully open position in which the flow of minor gas has its maximum value d_{max i}, d_{max i+1}, . . . , and the regulator members 41, 42, 43, 44 may take up at least one intermediate position between the closed position and the open position.

Advantageously, the regulator members are configured such that, when they take up their intermediate position, the flow of minor gas is delivered with its minimum value d_{min i}, d_{min i+1}, . . . , the minimum value corresponding to a flow of minor gas equal to at least 20%, preferably at least 25%, more preferably at least 35%, or even at least 50%, of the respective maximum value of each regulator member. This makes it possible to work in flow ranges where the accuracy of the regulator members, more specifically the accuracy of the flow sensors used in the regulator members, is highest.

Preferably, the second flow regulator device 9, FC1 comprises a pressure raising member 9, in particular a pump or a compressor, at least one operating parameter of which determines the flow of gas mixture flowing toward the container 10.

The second flow regulator device may also comprise a speed variator for varying the speed of a motor of the pressure raising member 9. The flow of gas mixture flowing toward the container 10 varies depending on the position of the speed variator which determines the speed of variation of the motor.

The second flow regulator device may comprise at least a first flow controller FC1 associated with the speed variator. For example, the pressure raising member 9 may be equipped with a variable speed motor, said motor comprising a speed variator controlled by the first controller FC1.

The first flow controller FC1 receives control signals representative of the second flow setpoint D. The flow of gas mixture flowing toward the container 10 is measured and compared with the second setpoint in order to adjust accordingly the speed of rotation of the motor and the flow of the mixture to make it tend toward the setpoint value.

The control unit 5 is electrically or electromagnetically connected to the second regulator device 9 in such a way as to control the operation thereof in accordance with the second flow setpoint D. It is also possible for the second regulator device 9 to be controlled by a system independent of the control unit and connected to or integrated in the first flow controller FC1.

According to one possibility, the second transfer circuit 7 comprises a flow sensor or flow meter FC2 configured to measure the flow of carrier gas flowing as far as the mixer device 3. This makes it possible to find out the flow value so as to adjust the flow of minor gas and thereby the concentration of minor gas in real time.

Preferably, the first and second transfer circuits are each provided with an expansion member 15, 16, such as a pressure reducer or a valve, and with a pressure sensor PC making it possible to measure the pressure prevailing in these circuits. This reduces the pressure of the gases which are most often stored in the form of compressed gases at high pressure, typically more than 20 bar, in their containers. This ensures greater accuracy of the composition of the mixture. The minor and carrier gases are each preferably maintained at constant pressures during their delivery to the mixer device 3, preferably between 1 and 10 bar (g) (bar gauge).

Preferably, a heater 17, 18 is arranged upstream of each expansion member 15, 16 so as to heat the gases before their expansion. This helps compensate for the cooling caused by the Joule-Thomson effect during the adiabatic expansion of the gas.

According to an advantageous embodiment, two expansion members may optionally be arranged in series, preferably with another heater arranged between two expansion members. To be specific, during the expansion of gas at high pressure, the temperature of the heaters can reach 70 to 100° C. Using two levels of expansion makes it possible to reduce the phenomenon of overheating in the heaters, as well as to reduce the heating power of each heater. Preferably, the heating power of each heater is controlled individually as a function of the pressure before expansion and the desired pressure after expansion. Note that at least one heater and at least one pressure reducer may also be arranged on the additional transfer circuits if necessary.

Furthermore, the plant may comprise an analysis unit 14 configured to measure at least one content of minor gas and/or carrier gas in the gas mixture produced at the outlet 33 of the mixer device 3. The control unit 5 is electrically or electromagnetically connected to the analysis unit 14 and receives from the analysis unit 14 a measurement signal representative of said at least one measured content. In operation, the control unit 5 performs at least one comparison between said measured content and the corresponding target content of minor gas and/or carrier gas. Preferably, the analysis unit 14 is configured to analyse only the content of minor gas in the gas mixture.

Depending on the result of the comparison, the control unit 5 is configured to maintain or adjust the first flow setpoint D1 applied to the first regulator device 4 in such a way as to maintain the measured content or cause it to tend toward the target content. This makes it possible to adjust the proportion of the first flow setpoint D1 in relation to the delivery flow D such that the actual composition of the gas mixture leaving the mixer device 3 is close to the target composition.

This control of the contents of the mixture produced by the mixer device makes it possible to compensate for possible errors between the flow actually regulated by the first flow regulator device 4 and the flow setpoint D1 applied thereto. The mixer device 3 produces a mixture which can be monitored continuously. Note that a difference between the measured and target contents may also stem from uncertainty regarding the delivery flow of the mixture which may not correspond exactly to the second flow setpoint D applied to the second regulator device 9.

In particular, the control unit 5 may include a feedback control loop for controlling the flow of minor gas on the measurement signal provided by the analysis unit 14. The term “feedback control loop” is generally understood to mean a system for controlling a process in which a regulating quantity acts on a regulated quantity, i.e. a quantity to be feedback-controlled, in order to bring it as quickly as possible to a setpoint value and maintain it thereat. The basic principle of feedback control is to measure, continuously, the difference between the actual value of the quantity to be feedback-controlled and the setpoint value that it is desired to achieve, and to calculate the appropriate command to be applied to one or more actuators so as to reduce this difference as quickly as possible. It is also referred to as a closed-loop controlled system. In the feedback control loop, the regulating quantities are the content(s) measured by the analysis unit 14, and the regulated quantity is the flow of minor gas. The first setpoint D1 is variable depending on the actual content(s) measured.

Said loop comprises a comparator arranged within the control unit 5 and configured to produce at least one error signal from a comparison of the measurement signal with the target content C1 of minor gas and/or the target content C2 of carrier gas. The loop further comprises a corrector, in particular of proportional, integral and derivative (PID) type, which makes it possible to improve the performance of feedback owing to three combined actions: a proportional action, an integral action, a derivative action.

The corrector may in particular comprise a microprocessor, memory registers, programming instructions for processing the first error signal and producing, by numerical calculation, the proportional, integral and derivative terms of the feedback control loop. These terms, which may be determined by calculation and/or experimentally, are combined to provide the control signal for the regulator members 41, 42. The derivative term of D may potentially be zero.

The corrector is configured to produce the control signal from the error signal representative of a difference between the target content and the measured content. If there is a difference, the first flow setpoint D1 is modified in accordance with the first control signal. The regulator members 41, 42, 43, 44 are connected to the corrector and configured to move in response to said control signal in such a way as to reduce the difference.

Preferably, the control signal is produced from an error signal containing at least one piece of information on the difference between a measured content and a target content, for the minor gas. This difference may in particular be expressed using the formula: ΔC1=(M1−C1)/(C1), where M1 is the measured content for the first gas. The relative difference ΔC1 may be used as a correction factor for the first flow setpoint D1.

Note that the analysis unit may also make it possible, during start-up of the plant or during filling of the container 10, to condition the delivery of the gas mixture so that the measured contents comply with the target contents. A tolerance of the order of at most 1%, indeed at most 0.7% (relative %), relative to the target contents C1, C2 may be set. If the mixture produced does not comply, filling may optionally be stopped.

The gas mixture produced may optionally be delivered to a vent fluidically connected to the delivery circuit 8, in particular in the case where the composition of the mixture does not comply with the target composition.

The line that samples the mixture and conveys it to the analysis unit 14 advantageously has the shortest possible length so that the analyzer provides a very accurate response in real time or in virtually real time. Preferably, the line is such that the interval between the moment when the mixture is sampled at its sampling point and the moment when the analysis unit gives its measurement is minimal, typically less than 30 seconds, in particular between 1 and 30 seconds.

Advantageously, the delivery circuit 8 comprises a buffer tank 11. Preferably, the buffer tank 11 is arranged between the mixer device 3 and the second flow regulator device 9, FC1. The buffer tank 11 makes it possible to dampen the pressure fluctuations at the inlet of the second flow regulator device 9 and to complete the homogenization of the mixture leaving the mixer.

Preferably, the analysis unit 14 is fluidically connected to the delivery circuit 8 at a sampling point located between the outlet of the mixer device and the inlet of the buffer tank 11. This makes it possible to detect and react more quickly to any variations in contents, further reducing the risk of packaging a non-compliant mixture in the container 10.

Optionally, the plant may comprise an alarm configured to emit an alarm signal if the analysis unit detects contents outside of the anticipated tolerance ranges.

The analysis unit 14 may be chosen in particular from the following types of detectors: a thermal conductivity detector, a paramagnetic alternating pressure detector, a catalytic adsorption detector, a non-dispersive infrared absorption detector, an infrared spectrometer. The type of analysis unit may be adapted according to the nature of the gases to be analyzed.

Preferably, only the first setpoint D1 is adjusted as a function of the measurement from the analysis unit 14, the control unit 5 commanding that the second setpoint D be maintained. It being understood that it is possible for D to also be adjusted in response to the control signal.

As shown in FIG. 1, the plant advantageously comprises several containers 10 fluidically connected to the delivery circuit 8 by a filling station 60. The filling station 60 is configured for filling several containers 10 from the same delivery circuit 8, which is particularly beneficial in terms of filling efficiency and homogeneity of composition of the mixture from one container 10 to another. The filling station 60 may be connected to an independent control system or to the control unit 5. The filling station 60 preferably comprises a set of automatic valves which are configured to open when a container is being filled and close when the desired quantity of gas mixture has been introduced into the container. The automatic valves may be connected to a system for measuring the quantity of gas in each container, such as a device for weighing each container 10, such that when the desired quantity of gas is reached in the container in question, the corresponding automatic valve is closed and the automatic valve of another container is opened in order to fill the latter.

The plant according to the invention may in particular be used to produce gas mixtures having the following compositions:
hydrogen (H2) in an inert gas such as nitrogen (N2), argon or helium,
helium in an inert gas such as nitrogen or argon,
carbon monoxide (CO) in an inert gas such as nitrogen, argon or helium,
carbon dioxide (CO2) in an inert gas such as nitrogen, argon or helium,
methane (CH4) in an inert gas such as nitrogen, argon or helium,
oxygen (O2) in an inert gas such as nitrogen, argon or helium,
nitrogen monoxide (NO) in an inert gas such as nitrogen, argon or helium,
propane (C3H8) in an inert gas such as nitrogen, argon or helium,
N2 as minor gas in an inert gas such as argon or helium.

Preferably, the target contents C1 of minor gas are between 1% and 40%, preferably between 2% and 20%, the remainder being the carrier gas.

The plant according to the invention may also be used to produce gas mixtures such as those used in the field of electronics, in particular in the production of integrated circuits and the fabrication of semiconductors, in particular the doping of silicon wafers. The gas mixture may thus comprise a carrier gas such as argon, nitrogen, helium and at least one dopant gas as minor gas, the formula of which contains for example germanium, phosphorus, arsenic, antimony, boron, gallium, aluminum.

It should be noted that the present description describes a gas mixture containing two constituents but that it can be transposed to any mixture having a greater number of constituents. For example, in the case of a ternary gas mixture, three sources deliver two types of minor gas and a carrier gas. Flow regulator members receive the order from the control unit 5 to regulate the flow of each minor gas to a respective flow setpoint D1A, D1B. The mixer device is configured to deliver a mixture of flow D equal to the sum of D1A, D1B, D2. All or some of the features already described for a mixture containing two gases may be transposed to this mixture containing three or more gases.

FIG. 3 schematically shows an embodiment of a plant having two sources of minor gas 1A, 1B each connected to a first transfer circuit 6A, 6B as described above. The first transfer circuits 6A, 6B each comprise a first flow regulator device 4A, 4B configured to regulate the flow of minor gas flowing toward the mixer device 3 according to a flow setpoint determined as a function of a target content of each of the minor gases in the gas mixture. Advantageously, the plant comprises third fluidic connection means 20A, 20B each arranged in a transfer circuit 6A, 6B between a respective first flow regulator device 4A, 4B and the mixer device (3). Each of the third fluidic connection means 20A, 20B comprises at least one delivery valve. The delivery valve, depending on its position, prevents or allows the passage of the minor gas toward the mixer device 3. The isolation valve is configured in such a way as to be able to fluidically isolate the delivery valve from the mixer 3. This ensures that each minor gas delivered by the flow regulator device 4A, 4B is available quickly because it is waiting under pressure upstream of third fluidic connection means 20A, 20B.

Preferably, the isolation valve and the delivery valve are connected by a line portion to which a pressure measurement member and a discharge valve are connected. In the event of failure of one of the valves, particularly in the event of a leak, an abnormal build-up of gas occurs in the line portion, which causes an increase in the pressure measured by the measurement device. If this pressure exceeds a certain threshold, opening of the discharge valve can be triggered, in particular by the control unit 5, in order to vent the gas that has built up and thus prevent it from contaminating the minor gas or the gas mixture. The accuracy of the mixture is thus further improved. The plant may be used to deliver a mixture comprising one or other of the minor gases, as required. The sources of minor gas are available on site and the desired source is connected with its flow regulator device to the mixer device. It may also be envisaged connecting the two sources of minor gas 1A, 1B to the mixer device in such a way as to deliver a mixture containing the two minor gases.

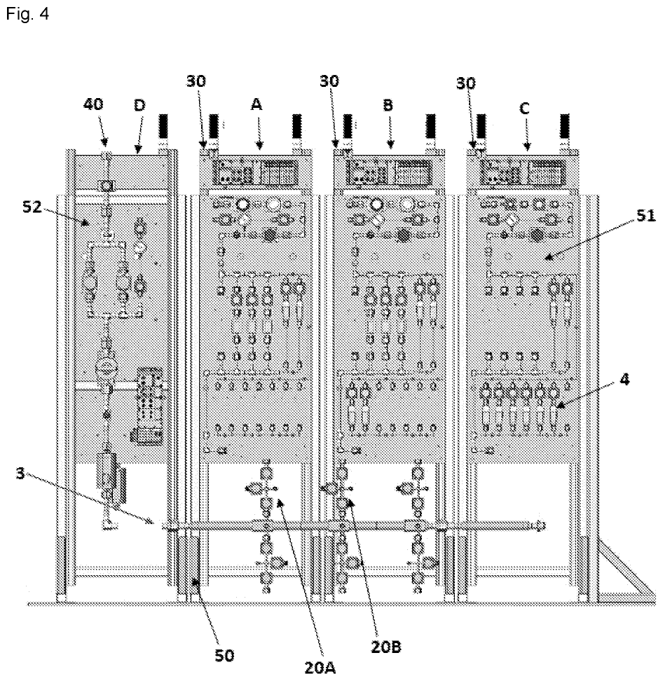

FIG. 4 schematically shows an embodiment of a plant comprising several minor gas modules A, B, C, a carrier gas module D and means for removably securing 50 said modules to one another. Each minor gas module comprises a first wall 51 to which are attached a first transfer circuit 6 and first means for fluidic connection 30 of the first transfer circuit 6 to a respective source of minor gas 1A. Each carrier gas module has a second wall 52 to which are attached the second transfer circuit 7 and second means for fluidic connection 40 of the second transfer circuit 7 to a source of carrier gas 2. Third fluidic connection means 20 are provided to selectively connect the mixer device 3 to one or more first transfer circuits 6 and to the second transfer circuit 7.

In this embodiment, the gas sources of the plant, the control unit 5, the gas modules are positioned at a distance from one another and form physically distinct and independently movable assemblies. The advantage of such an arrangement is that it can be modulated according to the user's needs in terms of the nature and flow rate of the gases in the mixture. Modules may be added or removed from the plant in order to adapt to a change in the constituents of the mixture. Within the same module, elements such as pressure reducers, gas heaters, flow regulator members may also be added or removed to adapt to a change in target content and therefore to a change in the flow desired for the minor gas.

Modules include gas inlet openings for supply with minor and carrier gases. Other gas inlets may be provided, notably for a flushing gas, or a calibration gas for calibrating the analysis unit.

The following may also be provided within the modules, being attached to the walls in a manner known in the prior art: a buffer tank, a gas pipe system, means for control and/or maintenance of the gas pipe system such as valves, pressure reducers, pressure measurement members, etc. making it possible to carry out operations such as gas delivery, opening or closing of certain pipes or portions of pipes, management of the gas pressure, carrying out purge cycles, leak tests, etc.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the of scope “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A plant for packaging a gas mixture in at least one container (10), said plant comprising:
a source of a minor gas (1),
a source of a carrier gas (2),
a mixer device (3) fluidically connected to the source of minor gas (1) and to the source of carrier gas (2), said mixer device (3) being configured to produce, at an outlet (33), a gas mixture comprising the carrier gas and the minor gas,
a first transfer circuit (6) fluidically connecting the source of minor gas (1) to the mixer device (3), the first transfer circuit (6) comprising a first flow regulator device (4) configured to regulate the flow of minor gas flowing toward the mixer device (3) according to a first flow setpoint (D1) determined as a function of a target content (C1) of minor gas in the gas mixture,
a second transfer circuit (7) fluidically connecting the source of a carrier gas (2) to the mixer device (3),
a delivery circuit (8) configured to deliver the gas mixture from the mixer device (3) to said at least one container (10), the delivery circuit (8) comprising a second flow regulator device (9, FC1) configured to regulate the flow of the gas mixture flowing toward the at least one container (10) according to a second flow setpoint (D),
the second flow regulator device (9, FC1) comprising a pressure raising member (9), the first flow regulator device (4) comprising several regulator members (41, 42, 43, 44) configured to regulate the flow of minor gas over respective flow ranges, the regulator members (41, 42, 43, 44) being arranged in parallel in the first transfer circuit (6), the plant comprising a control unit (5) connected to the regulator members (41, 42, 43, 44) and configured to select at least one of the regulator members (41, 42, 43, 44) on the basis of at least one comparison of the first flow setpoint (D1) with a minimum value and/or a maximum value of at least one of the flow ranges, the control unit (5) being configured to control the regulator members (41, 42, 43, 44) in such a way as to allow the minor gas to flow between the source of minor gas (1) and the mixer device (3) via said at least one selected regulator member (41, 42, 43, 44) and in such a way as to prevent the minor gas from flowing between the source of minor gas (1) and the mixer device (3) via the non-selected regulator member(s) (41, 42, 43, 44), the first flow regulator device (4) comprising a flow meter associated with each of the regulator members (41, 42, 43, 44) each.

2. The plant of claim 1, characterized in that the first transfer circuit (6) and the second transfer circuit (7) each include an expansion member (15, 16).

3. The plant of claim 1, characterized in that the flow meter comprises a mass flow meter and in that the regulator member comprises a valve, in particular a piezoelectric valve.

4. The plant of claim 1, characterized in that the control unit (5) is configured to select a regulator member (41, 42, 43, 44) for which the first flow setpoint (D1) is between the minimum flow value and the maximum flow value of the flow range of said regulator member (41, 42, 43, 44).

5. The plant of claim 1, characterized in that when the first flow setpoint (D1) is greater than the highest maximum value of the flow ranges of the regulator members (41, 42, 43, 44), the control unit (5) is configured to select the regulator member (41, 42, 43, 44) having the flow range with the highest maximum value, to determine at least one new flow setpoint (Dₙ) equal to the difference between the first flow setpoint D1 and said highest maximum value and to select at least one other regulator member (41, 42, 43, 44) such that the new flow setpoint (Dₙ) is between the minimum flow value and the maximum value of the flow range of said other regulator member (41, 42, 43, 44).

6. The plant of claim 1, characterized in that the first flow regulator device (4) comprises several regulator members configured to regulate the flow of minor gas toward the mixer device (3) over successive flow ranges (Pᵢ, Pᵢ₊₁, . . . ) having increasing minimum values (d_{min i}, d_{min i+1}, . . . ) and increasing maximum values (d_{max i}, d_{max i+1}, . . . ), the maximum value (d_{max i}) of at least one flow range (Pᵢ) being between the minimum value (d_{min i+1}) and the maximum value (d_{max i+1}) of the successive flow range, the control unit (5) being configured to select the regulator member (41) having the smallest minimum flow value (d_{min i}) when the flow setpoint (D1) or the new flow setpoint (Dₙ) is between the maximum value (d_{max i}) of said at least one flow range (Pᵢ) and the minimum value (d_{min i+1}) of said successive flow range (Pᵢ₊₁).

7. The plant of claim 6, characterized in that the extent of said at least one flow range (Pᵢ) is defined as the difference between its minimum value (d_{min i}) and its maximum value (d_{max i}) and the extent of the overlap zone is defined as the difference between the maximum value (d_{max i}) of said at least one flow range (Pᵢ) and the minimum value (d_{min i+1}) of said successive flow range (Pᵢ₊₁), the overlap zone representing between 15 and 50%, preferably between 15 and 30%, of the extent of said at least one flow range (Pᵢ).

8. The plant of claim 6, characterized in that each of the regulator members (41, 42, 43, 44) may move between a closed position in which the flow of minor gas is zero and a fully open position in which the flow of minor gas has its maximum value (d_{max i}, d_{max i+1}, . . . ), and the regulator members (41, 42, 43, 44) may take up at least one intermediate position between the closed position and the open position in which the flow of minor gas has its minimum value (d_{min i}, d_{min i+1}, . . . ), the minimum value corresponding to a flow of minor gas equal to at least 20%, of the respective maximum value.

9. The plant of claim 1, characterized in that the first transfer circuit (6) comprises fluidic isolation valves (61, 62, 63, 64) associated with each of the regulator members (41, 42, 43, 44), said fluidic isolation valves (61, 62, 63, 64) being operable in such a way as to allow the minor gas to flow between the source of minor gas (1) and the mixer device (3) via said at least one selected regulator member (41, 42, 43, 44) and to prevent the minor gas from flowing between the source of minor gas (1) and the mixer device (3) via the other non-selected regulator member(s) (41, 42, 43, 44).

10. The plant of claim 1, further comprising several sources of minor gas (1A, 1B), several first transfer circuits (6A, 6B) fluidically connecting each of the sources of minor gas (1A, 1B) to the mixer device (3), the first transfer circuits (6A, 6B) each comprising a first flow regulator device (4A, 4B) configured to regulate the flow of minor gas flowing toward the mixer device (3) according to a first flow setpoint (D1) determined as a function of a target content (C1) of minor gas in the gas mixture, the plant further comprising third fluidic connections (20A, 20B) each arranged in a transfer circuit (6A, 6B) between a-respective first flow regulator devices (4A, 4B) and the mixer device (3), each of the third fluidic connections (20A, 20B) comprising at least one delivery valve movable in position in such a way as to allow or prevent the delivery of the minor gas coming from the first flow regulator device (4A) and an isolation valve arranged downstream of the delivery valve, said isolation valve being configured to fluidically isolate the delivery valve from the mixer device (3) when the delivery valve is in a position preventing the delivery of the minor gas.

11. The plant of claim 1, characterized in that the second flow regulator device comprises a speed variator for varying the speed of a motor of the pressure raising member (9), the rotation speed of said motor determining the flow of gas mixture flowing toward the container (10), the second flow regulator device comprising a first flow controller (FC1) connected to the speed variator and configured to measure the flow of gas mixture flowing toward said container (10), the first flow controller (FC1) being configured to control and/or adjust a position of the flow variator device in such a way as to cause the flow of gas mixture measured to tend toward the second flow setpoint (D).

12. The plant of claim 1, characterized in that the second transfer circuit (7) comprises a flow sensor or flow meter (FC2) configured to measure the flow of carrier gas flowing as far as the mixer device (3).

13. The plant of claim 1, further comprising an analysis unit (14) configured to measure at least a content of minor gas and/or carrier gas in the gas mixture produced at the outlet (33) of the mixer device (3), the control unit (5) being connected to the analysis unit (14) and configured to produce a control signal on the basis of at least one comparison of said at least one measured content with at least a target content (C1) of minor gas and/or a target content (C2) of carrier gas, and to adapt the first flow setpoint (D1) in response to said control signal.

14. The plant of claim 13, characterized in that the analysis unit (14) produces a measurement signal representative of said at least one measured content, the control unit (5) comprising a loop for regulating the first flow setpoint (D1) on the measurement signal supplied by the analysis unit (14), said loop comprising:
a comparator arranged within the control unit (5) and configured to produce at least one error signal from a comparison of the measurement signal with at least one parameter chosen from: a target content (C1) of minor gas, a target content (C2) of carrier gas,
a corrector arranged within the control unit (5), in particular of proportional, integral and derivative (PID) type, and configured to produce the control signal from the error signal,
the regulator members (41, 42, 43, 44) being connected to the corrector and configured to move into position in response to said control signal.

15. The plant of claim 1, characterized in that the delivery circuit (8) comprises a buffer tank (11) arranged between the mixer device (3) and the pressure raising member (9).

16. The plant of claim 1, characterized in that it comprises several containers (10) fluidically connected to the delivery circuit (8) by at least one filling station (60).

17. The plant of claim 1, further comprising several removably secured (50) modules, which modules include:
one or more minor gas modules (A, B, C), each minor gas module having a first wall (51) to which are attached a first transfer circuit (6) and first fluidic connection (30) of the first transfer circuit (6) to a respective source of minor gas (1),
one or more carrier gas modules (D), each carrier gas module having a second wall (52) to which are attached the second transfer circuit (7) and second fluidic connection (40) of the second transfer circuit (7) to a respective source of carrier gas (2),
third fluidic connection means (20A, 20B) configured to selectively connect the mixer device (3) to one or more first transfer circuits (6) and to one or more second transfer circuits (7).

18. A method for packaging a gas mixture, comprising the following steps:
a) passing a minor gas (1) through a first transfer circuit (6) comprising a first flow regulator device (4) in such a way as to deliver the minor gas (1) to a mixer device (3) according to a first flow setpoint (D1) determined as a function of a target content (C1) of minor gas in the gas mixture,
b) passing a carrier gas (2) through a second transfer circuit (7) in such a way as to deliver the carrier gas (2) to the mixer device (3),
c) producing, through an outlet (33) of the mixer device (3), a gas mixture comprising the minor gas and the carrier gas,
d) passing the gas mixture through a delivery circuit (8) comprising a second flow regulator device (9, FC1) in such a way as to deliver the gas mixture to said at least one container (10) according to a second flow setpoint (D), the second flow regulator device (9, FC1) comprising a pressure raising member (9), the first flow regulator device (4) comprising several regulator members (41, 42, 43, 44) arranged in parallel in the first transfer circuit (6), the regulator members (41, 42, 43, 44) being configured to regulate the flow of minor gas over respective flow ranges, the method further comprising the following steps:
e) comparing the first flow setpoint (D1) with at least one minimum value and/or at least one maximum value of at least one of the flow ranges,
f) selecting at least one of the regulator members (41, 42, 43, 44) on the basis of the comparison carried out in step e) and controlling the regulator members (41, 42, 43, 44) in such a way as to selectively allow the minor gas to flow between the source of minor gas (1) and the mixer device (3) via said at least one selected regulator member (41, 42, 43, 44) and in such a way as to prevent the minor gas from flowing between the source of minor gas (1) and the mixer device (3) via the non-selected regulator member(s) (41, 42, 43, 44).
